(19) United States
(12) Patent Application Publication
(10) Pub. No.: US 2006/0206600 A1
(43) Pub. Date: Sep. 14, 2006

(54) Method of operating a video-on-demand system that prevents congestion

(76) Inventors: Allen Tsz-Chiu Wong, San Jose, CA (US); Zhidan Cheng, Sunnyvale, CA (US)

Correspondence Address: LAW OFFICES OF MARK C. PICKERING, P.O. BOX 300, PETALUMA, CA, 94953, US

(21) Appl. No.: 11/075,570

(22) Filed: Mar. 8, 2005

(51) Int. Cl. G06F 15/173

(52) U.S. Cl. 709/223

(57) ABSTRACT

A video-on-demand (VOD) system utilizes an access platform that has a controller, and uplink and downlink cards that support a predetermined number of unicast and multicast data streams. When a VOD application server receives a request from an end user to receive a unicast data stream, the VOD application server reserves the needed bandwidth from the controller, which insures that the predetermined number of unicast data streams are not exceeded, thereby preventing congestion related problems.

### BACKGROUND OF THE INVENTION

1. Field of the Invention

The present invention relates to video on demand and, more particularly, to a method of operating a video-on-demand system that prevents congestion.

2. Description of the Related Art

An IP-based video-on-demand (VOD) system is a system that provides video content to an end user over the internet whenever the end user wishes to receive the video content. IP-based VOD systems commonly utilize a set top box, which is connected to the end user's television and the internet via an xDSL modem. In operation, the set top box decodes and provides the video content to the end user's television.

FIG. 1 shows a block diagram that illustrates a prior-art VOD system 100. As shown in FIG. 1, system 100 includes an xDSL modem 110 which has an input port that receives and transmits telephonic signals and data packets. In addition, xDSL modem 110 has a plain old telephone service (POTS) port that receives and transmits telephonic signals to a residential telephone (not shown), and a data port that receives and transmits data packets.

As further shown in FIG. 1, system 100 also includes a set top box 112 and a personal computer 114 that are connected in parallel to the data port, and a television 116 that is connected to set top box 112. Set top box 112 and television 116 provide a user interface to system 100.

In addition, system 100 includes an access platform 120 that has a number of xDSL line cards 122 that each route telephonic signals and data packets to a number of xDSL modems, such as xDSL modem 110. Access platform 120, which typically resides in a central office, also has a control bus 124 that is connected to the xDSL line cards 122. Control bus 124, which passes only non-packet control messages, can be implemented with, for example, a low-speed, Ethernet-type bus.

Further, access platform 120 includes a number of source line cards 126 that are connected to control bus 124. Each source line card 126 receives a number of unicast and multicast data streams from a content provider. Access platform 120 additionally includes a fabric switch module card 130 that is connected to control bus 124, and between the xDSL line cards 122 and the source line cards 126. Fabric switch module card 130 passes data packets between the xDSL line cards 122 and the source line cards 126 at up to OC12 speeds.

Further, access platform 120 can also include a primary control module (PCM) card 132 that is connected to control bus 124. PCM card 132 includes a memory and a processor that is connected to the memory. The memory includes a first PCM table that lists the unicast and multicast data streams that are received by each source line card 126, and a second PCM table that lists the unicast and multicast data streams that are received by each xDSL line card 122.

As further shown in FIG. 1, system 100 also includes a VOD content provider 134, which has a VOD application server 136A and a VOD content server 136B, that is connected to a source line card 126A via the internet 138. VOD application server 136A provides a user interface which allows the end user to set up an account, select video content to be viewed, and enter user commands. VOD content server 136B, on the other hand, stores large numbers of videos and outputs streams of unicast data packets that represent the videos to specific IP addresses.

In operation, when an end user wishes to view a video, such as a movie, the end user turns on set-top box 112 which, in turn, provides a menu of choices that are displayed on television 116. When the end user makes a choice, set top box 112 converts the choice into a data packet which is addressed and output to VOD application server 136A via modem 110.

VOD application server 136A receives the choice from the end user, verifies the end user's account status and the availability of the content and, when all requirements are in order, outputs a message to VOD content server 136B to begin a unicast data stream to the IP address associated with the end user.

When source line card 126A receives the data packets associated with the unicast data stream, card 126A notifies PCM card 132 (which makes entries in the first and second PCM tables), obtains routing information to the proper xDSL line card 122, and forwards the data packets to fabric switch module card 130. Card 130 transmits the data packets on to the proper xDSL line card 122 which, in turn, forwards the data packets on to set top box 112 via modem 110.

Like a VCR or a DVD player, set top box 112 provides standard user commands, such as play, stop, fast forward, rewind, and pause that allow the end user to control the selected video content as the end user desires for a predetermined period of time. When the end user selects a command, such as stop, set top box 112 converts the command into a data packet which is addressed and output to VOD application server 136A via modem 110.

VOD application server 136A receives the command from the end user and, in response, outputs a stop message to VOD content server 136B. When the stop message is received, VOD content server 136B stops outputting the unicast data stream to the end user. VOD content server 136B only resumes the unicast data stream to the end user when another message, such as play, is received from VOD application server 136A.

One problem with VOD system 100 is that, when a large number of end users simultaneously wish to view a video via system 100, a source line card 126, which is also supporting a large number of multicast data streams, can become congested. Each unicast data stream requires a bandwidth of approximately 3.6 Mbps for standard television viewing. High definition television viewing requires substantially more bandwidth.

When a source line card 126 becomes congested due to the large number of unicast data streams that must be processed by the card 126, the data packets within the data streams can be delayed or even dropped. This, in turn, can lead to a poor viewing experience by the end user. Thus, there is a need for an approach of insuring that the end user continues to have a high quality viewing experience even when a large number of end users simultaneously wish to view a video.

### SUMMARY OF THE INVENTION

A method of operating a controller is disclosed according to a first embodiment of the present invention. In the embodiment, a value is checked to determine if a first message has been received from a server. The first message has an associated uplink card and an associated downlink card. In addition, a value is checked to determine if a second message has been received from the server when the first message has not been received.

A method of operating a server is disclosed according to a second embodiment of the present invention. In the embodiment, a value is checked to determine if a request has been received from an end user. In addition, a first message is output to a controller when the request has been received. The first message has an associated uplink card and an associated downlink card.

A machine-readable medium is disclosed according to a third embodiment of the present invention. The machine-readable medium has sequences of instructions stored thereon, the sequences of instructions including instructions which, when executed by a processor, causes the processor to determine if a first message has been received from a server, and determine if a second message has been received from the server when the first message has not been received. The first message has an associated uplink card and an associated downlink card.

A machine-readable medium is disclosed according to a fourth embodiment of the present invention. The machine-readable medium has sequences of instructions stored thereon, the sequences of instructions including instructions which, when executed by a processor, causes the processor to determine if a request has been received from an end user, and output a first message to a controller when the request has been received.

A better understanding of the features and advantages of the present invention will be obtained by reference to the following detailed description and accompanying drawings that set forth an illustrative embodiment in which the principles of the invention are utilized.

### BRIEF DESCRIPTION OF THE DRAWINGS

FIG. 1 is a block diagram illustrating a prior-art VOD system 100.

FIGS. 2A-2B are a flow chart illustrating a method 200 of operating a video-on-demand (VOD) application server in accordance with the present invention.

FIGS. 3A-3B are a flow chart illustrating a method 300 of operating a primary control module (PCM) card in accordance with the present invention.

FIG. 4 is a block diagram illustrating an example of a computer 400 in accordance with the present invention.

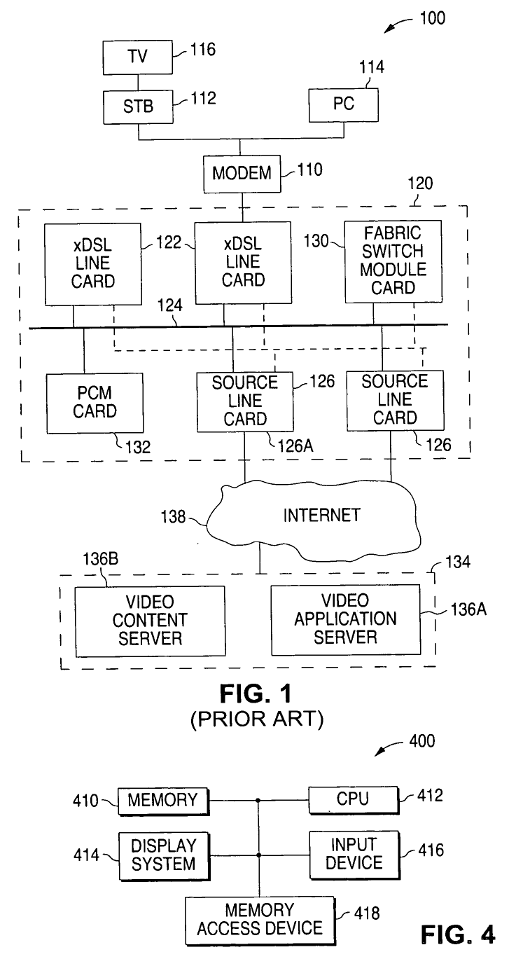

### DETAILED DESCRIPTION OF THE INVENTION

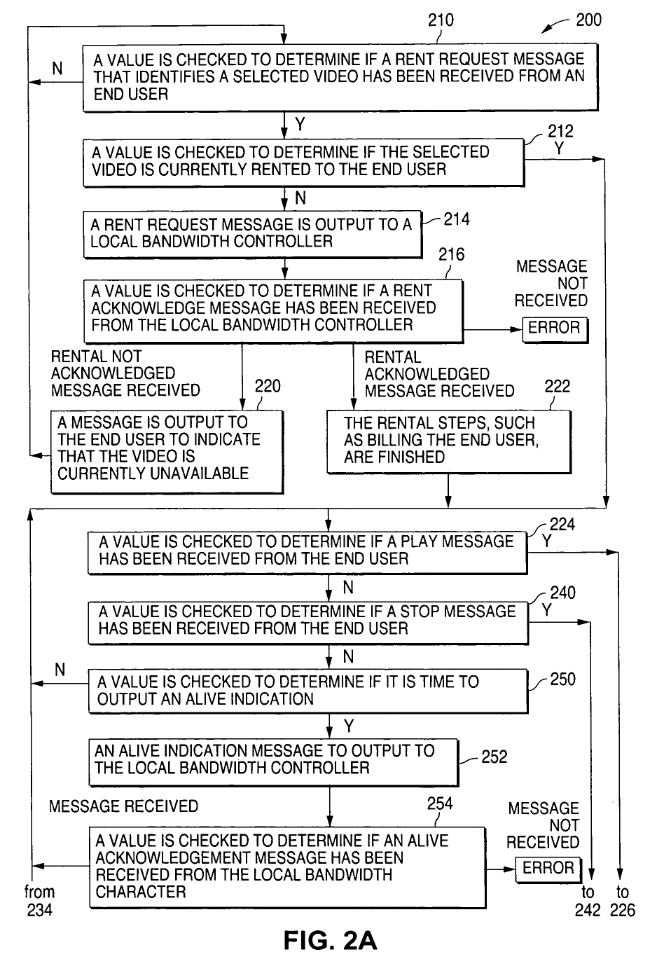

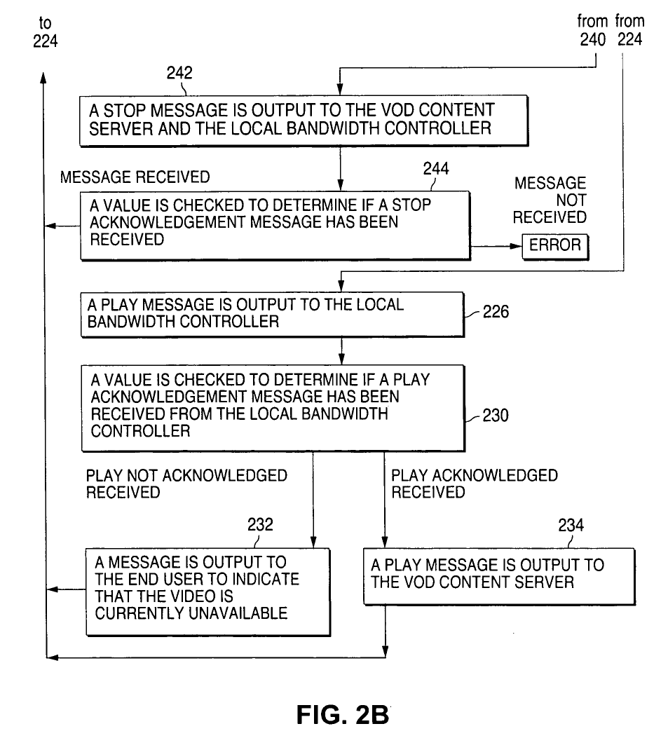

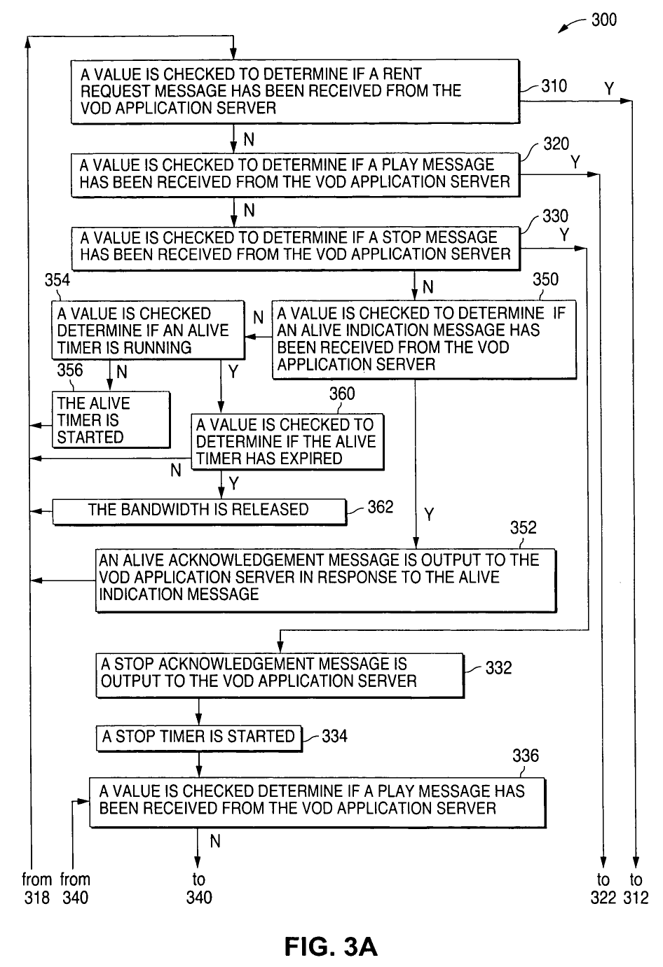

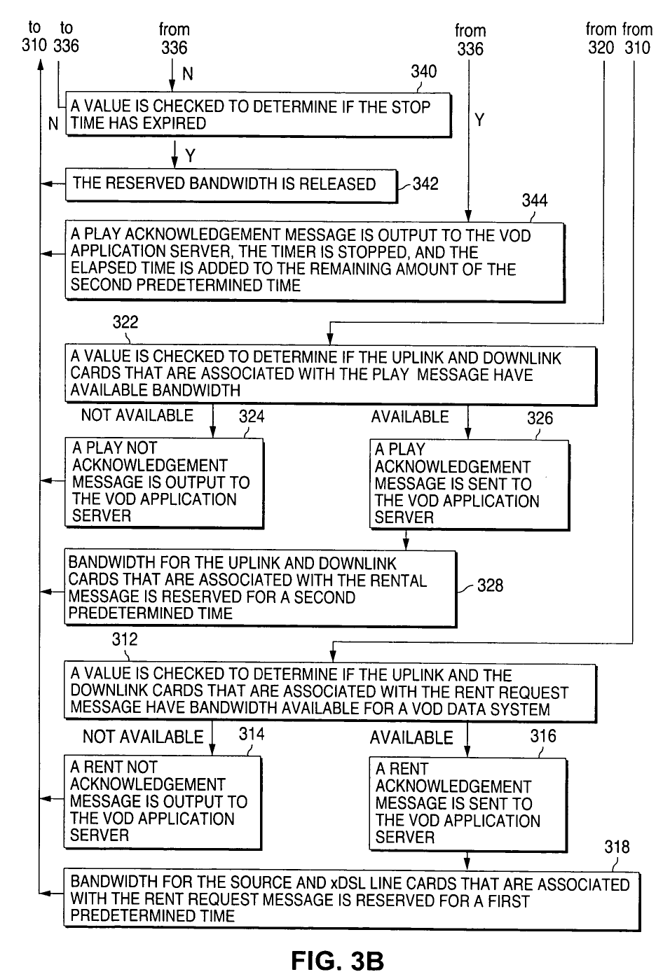

FIGS. 2A-2B show a flow chart that illustrates a method 200 of operating a video-on-demand (VOD) application server in accordance with the present invention. FIGS. 3A-3B show a flow chart that illustrates a method 300 of operating a local bandwidth controller in accordance with the present invention.

As described in greater detail below, methods 200 and 300 can be executed by a server and a controller, respectively, of a VOD system, such as server 134 and controller 132 of system 100, to reserve bandwidth for the unicast data streams of the VOD system. By reserving bandwidth, methods 200 and 300 insure that no congestion can arise which, in turn, insures that the end user's experience will not be interrupted after a connection has been established.

As shown in FIGS. 2A-2B, at 210, a value is checked to determine whether or not a rent request message has been received from an end user. The rent request message identifies a video that the end user has selected. For example, the end user can turn on a set top box and a television, and select a video to rent. The set top box can convert the selected video into a data packet which is sent to a VOD application server as the rent request message.

After the rent request message has been received, a value is checked in 212 to determine whether or not the selected video is currently rented to the end user. At 214, when the selected video has not yet been rented to the end user, a rent request message is output to a local bandwidth controller.

For example, the VOD application server can output a rent request message to a primary control module (PCM) card on an access platform, where the PCM card controls the bandwidths to the downlink cards, such as the xDSL line cards 122 of system 100, and the uplink cards, such as the source line cards 126 of system 100. After outputting the rent request message in 214, a value is checked in 216 to determine whether or not a rent acknowledge message has been received from the local bandwidth controller.

As shown in FIGS. 3A-3B, at 310, a value is checked to determine whether or not a rent request message has been received from a VOD application server. When method 200 outputs a rent request message to the local bandwidth controller in 214, method 300 detects the rent request message in 310.

When a rent request message is detected, a value is checked in 312 to determine whether or not the uplink and the downlink cards that are associated with the rent request message have bandwidth available for a VOD data stream. In method 300, the uplink and downlink cards are configured to allow a maximum number of unicast and multicast data streams.

At 314, when the maximum number of unicast data streams is being handled by one or both of the uplink and downlink cards, and therefore no unicast bandwidth is available, a rent not acknowledgement message is output to the VOD application server. On the other hand, at 316, when bandwidth is available, a rent acknowledgement message is sent to the VOD application server.

For example, the PCM card on an access platform includes a number of tables which, in turn, list the unicast and multicast data streams that are received by the different source line cards, and the unicast and multicast data streams that are received by the different xDSL line cards. The PCM card can also configured to allow the source line cards and the xDSL line cards a maximum number of unicast and multicast data streams.

Thus, when the PCM card on the access platform receives a rent request message from the VOD application server, the PCM card examines the tables. When the tables indicate that the source line card and the xDSL line card associated with the rent request message both have sufficient bandwidth to accommodate a VOD data stream, the PCM card makes an entry in the tables and notifies the VOD application server with the rent acknowledgement message. On the other hand, when the tables indicate that no more unicast bandwidth is available, the PCM card outputs the rent not acknowledgement message to the VOD application server.

At 318, when the rent acknowledgement message is sent, bandwidth for the source and xDSL line cards that are associated with the rent request message is reserved for a first predetermined time. The first predetermined time is an operator-defined value which can, for example, represent a time period that is sufficient for method 200 to complete an authorization process, thereby reserving bandwidth for enough time to complete the rental process in 222.

Referring again to FIGS. 2A-2B, method 200 determines in 216 whether the rent acknowledgement message or the rent not acknowledgement message was received (if no message is received, method 200 outputs an error message). At 220, when the rent not acknowledgement message is received in 216, a message is output to the end user to indicate that the video is currently unavailable. Following this, method 200 returns to 210. The end user can then make another selection, or retry the original selection.

At 222, when the rent acknowledgement message is received in 216, the rental steps, such as billing the end user, are finished. Following this, at 224, a value is checked to determine whether or not a play message has been received from the end user. Method 200 also checks the value to determine whether or not a play message has been received when method 200 determines in 212 that the selected video is currently rented to the end user.

When the play message is received from the end user, a play message is output in 226 to the local bandwidth controller. At 230, a value is checked to determine whether or not a play acknowledgement message or a play not acknowledgement message has been received from the local bandwidth controller.

Referring to FIGS. 3A-3B, when a rent request message is not received in 310, a value is checked in 320 to determine whether or not a play message has been received from the VOD application server. When method 200 outputs a play message in 226, method 300 detects the request in 320. At 322, when a play message is detected, a value is checked to determine whether or not the uplink and downlink cards that are associated with the play message have bandwidth available for a VOD data stream.

When no bandwidth is available, a play not acknowledgement message is output in 324 to the VOD application server. On the other hand, when bandwidth is available, a play acknowledgement message is sent in 326 to the VOD application server.

For example, when the PCM card on the access platform receives a play message from the VOD application server, the PCM card examines the tables. When the tables indicate that the source line card and the xDSL line card that are associated with the play message both have sufficient bandwidth to accommodate a VOD data stream, the PCM card notifies the VOD application server with the play acknowledgement message. On the other hand, when the tables indicate that no more unicast bandwidth is available, the PCM card outputs the play not acknowledgement message to the VOD application server.

Following this, in 328, bandwidth for the uplink and downlink cards that are associated with the rental message is reserved for a second predetermined time. The second predetermined time is an operator-defined value which can, for example, be equal to or greater than a running length time of a video, thereby reserving bandwidth for enough time to view the entire video.

Referring again to FIGS. 2A-2B, method 200 determines in 230 whether the play acknowledgement message or the play not acknowledgement message was received (if no message is received, method 200 outputs an error message). When the play not acknowledgement message is received, a message to the end user is output in 232 to indicate that the video is currently unavailable. When the play acknowledgement message is received, a play message is output in 234 to the VOD content server. In response, the VOD content server begins streaming data to the end user.

When the play message is not received in 224, a value is checked in 240 to determine whether or not a stop message has been received from the end user. When a stop message is received, a stop message is output in 242 to the VOD content server and the local bandwidth controller. Following this, a value is checked in 244 to determine whether or not a stop acknowledgement message has been received.

Referring to FIGS. 3A-3B, when a play message is not received in 320, a value is checked in 330 to determine whether or not a stop message has been received from the VOD application server. When method 200 outputs a stop message in 242, method 300 detects the request in 330. When a stop message is detected, a stop acknowledgement message is output in 332 to the VOD application server.

Following this, in 334, a stop timer is started. In 336, a value is checked to determine whether or not a play message has been received from the VOD application server. When a play message is not received, a value is checked in 340 to determine whether or not the stop timer has expired. When the stop timer expires, the reserved bandwidth is released in 342. When the stop timer has not expired, the value is again checked in 336 to determine whether a play message has been received.

When a play message is received in 336, a play acknowledgement message is output in 344 to the VOD application server. In addition, the timer is stopped, and the elapsed time is added to the remaining amount of the second predetermined time. Thus, if the end user takes a 10 minute break, the remaining amount of the second predetermined time is increased by 10 minutes so that the end user has bandwidth reserved until the end of the video.

Returning to FIGS. 2A-2B, when the stop message is not received in 240, a value is checked in 250 to determine whether or not it is time to output an alive indication to the local bandwidth controller to insure that the local bandwidth controller is still functioning properly. For example, the VOD application server can output an alive indication message once each second to the local bandwidth controller to insure that the local bandwidth controller is still functioning properly.

When it is time to output an alive indication, an alive indication message is output in 252 to the local bandwidth controller. Following this, a value is checked in 254 to determine whether or not an alive acknowledgement has been received from the local bandwidth controller.

Referring to FIGS. 3A-3B, when a stop message is not received in 330, a value is checked in 350 to determine if an alive indication message has been received from the VOD application server. When method 200 outputs an alive indication message in 252, method 300 detects the message in 350. When an alive indication message is detected, an alive acknowledgement message is output in 352 to the VOD application server.

When the local bandwidth controller, such as the PCM card, goes down, the VOD application server can detect this condition by detecting when the VOD application server does not receive an acknowledgement in 254 to the alive indication message sent out in 252. In addition, the VOD application server can detect that the local bandwidth controller has come back up because the VOD application server will again receive an alive acknowledgement message, followed by an all sessions query message from the local bandwidth controller. The VOD application server responds to the all sessions query indication message with an all session query acknowledgement message. The VOD application server then sends out a play message for each active VOD session to the local bandwidth controller, and receives a play acknowledgement message for each active VOD session from the local bandwidth controller.

When the VOD application server goes down, the local bandwidth controller can detect this condition by detecting the lack of an alive indication message for a predetermined period of time. When an alive indication message is not detected in 350, a value is checked in 354 to determine whether or not an alive timer is running.

If the alive timer is not running, the alive timer is started in 356. On the other hand, if the alive timer is running, a value is checked in 360 to determine whether or not the alive timer has expired. Only when the alive timer expires is the bandwidth released in 362.

When an alive indication message is received in 350 after the bandwidth has been released, the alive acknowledgement message is output in 352. In addition, method 300 outputs an all sessions query indication message to the VOD application server. The VOD application server responds to the all sessions query indication message with an all session query acknowledgement message. The VOD application server then sends out a play message for each active VOD session to the local bandwidth controller, and receives a play acknowledgement message for each active VOD session from the local bandwidth controller.

When the video finishes playing, the VOD application server receives a finish message from the VOD content server which indicates that the video is finished. In response, the VOD application server outputs a stop message to the VOD content server and the local bandwidth controller.

If an uplink card carrying VOD data streams reboots, the set top boxes receiving the VOD data streams from the uplink card will stop receiving the VOD data streams. In this case, the set top box enters a time out mode, exiting the time out mode when the VOD data stream returns. If the time out mode expires, the set top box returns to a default condition, such as receiving a multicast data stream. The VOD application server should send a stop message to the local bandwidth controller when the uplink card returns.

As noted above, the uplink and downlink cards in method 300 are operator-configured to allow a maximum number of unicast and multicast data streams. For example, assume that 200 multicast channels are provided to a downlink card that can support a maximum of 160 simultaneous 3.2 Mbit/sec channels. The channels, in turn, are provided to 96 homes with two users per home.

If a 10% ratio for VOD users is desired, 20 VOD streams (96 homes*2 users/home*10%) out of the 160 available data channels (which is 64M (20*3.2M)) must be used. The remaining 140 streams can then be used for multicast channels. Thus, 192 users (96 ports*2 users/port) can watch up to 140 different multicast channels simultaneously (out of 200).

This configuration guarantees the support of 10% VOD users at the expense of limiting the unique multicast channels to 140 on the downlink card. The uplink card, on the other hand, needs to support 200 multicast streams plus 20 VOD streams. As a result, in an embodiment where an uplink card supports only 150 channels, two uplink cards are required.

Thus, to support 288 (3*96) homes, two more downlink cards are required. Each card is capable of supporting 20 VOD streams and 140 multicast streams. As a result, the three downlink card system supports 60 VOD users. No additional uplink cards are required when two 150 stream uplink cards are used because the two uplink cards need only handle 260 streams (200 multicast streams and 60 VOD streams), which is less than the 300 streams carried by the two uplink cards.

If the number of unique multicast channels is reduced to 130, then 30 streams of VOD data can be assigned to each downlink card. When three downlink cards are utilized, then 90 VOD users can be supported. Alternately, none of the channels can be assigned to support VOD data streams such that all of the channels are utilized to support multicast data streams.

When two uplink cards are utilized, the two uplink cards support load balancing that equally distributes traffic either by destination IP address or loading. One choice is not to mix VOD traffic with multicast traffic on an uplink card. This dedicates a card to VOD traffic and a card to multicast traffic. If the VOD and multicast traffic are mixed on an uplink card, the multicast traffic should be equally distributed among all uplink cards.

FIG. 4 shows a block diagram that illustrates an example of a computer 400 in accordance with the present invention. Computer 400, which can be implemented with, for example, a Pentium4 3.4 GHz or comparable machine, can be used on a server to execute a sequence of instructions that implements method 200 of the present invention. Computer 400 can also be used on a control module to execute a sequence of instructions that implements method 300 of the present invention.

As shown in FIG. 4, computer 400 includes a memory 410 and a central processing unit (CPU) 412 that is connected to memory 410. Memory 410 stores data, an operating system, and a set of program instructions. The operating system can be implemented with, for example, the Linux operating system, although other operating systems can alternately be used. The program instructions can be written in, for example, C++ although other languages can alternately be used.

CPU 412, which can be implemented with, for example, a 32-bit processor, operates on the data in response to the program instructions. Although only one processor is described, the present invention can be implemented with multiple processors in parallel to increase the capacity to process large amounts of data.

In addition, computer 400 can include a display system 414 that is connected to CPU 412. Display system 414, which can be remotely located, allows images to be displayed to the user which are necessary for the user to interact with the program. Computer 400 also includes a user-input system 416 which is connected to CPU 412. Input system 416, which can be remotely located, allows the user to interact with the program.

Further, computer 400 includes a memory access device 418, such as a disk drive or a networking card, which is connected to memory 410 and CPU 412. Memory access device 418 allows the processed data from memory 410 or CPU 412 to be transferred to a computer-readable medium or a networked computer. In addition, device 418 allows the program instructions to be transferred to memory 410 from the computer-readable medium or networked computer.

In an alternative embodiment, hardware circuitry may be used in place of or in combination with software instructions to implement an embodiment of the present invention. As a result, the present invention is not limited to any specific combination of hardware circuitry and software.

Thus, method 200 and 300 of the present invention operate to request and reserve bandwidth for the unicast data streams of the VOD system. By reserving bandwidth, methods 200 and 300 insure that no congestion can arise because data streams which would lead to the congestion are not given permission to transmit. As a result, once a connection has been established, the present invention insures that the end user's viewing experience is not interrupted by congestion.

It should be understood that the above descriptions are examples of the present invention, and that various alternatives of the invention described herein may be employed in practicing the invention. Thus, it is intended that the following claims define the scope of the invention and that structures and methods within the scope of these claims and their equivalents be covered thereby.

What is claimed is:

1. A method of operating a controller, comprising:
determining if a first message has been received from a server, the first message having an associated uplink card and an associated downlink card; and
determining if a second message has been received from the server when the first message has not been received.

2. The method of claim 1, further comprising when a first message has been received, determining if the uplink and downlink cards associated with the first message have bandwidth available to support a unicast data stream.

3. The method of claim 2, further comprising:
outputting a negative acknowledgement message to the server when bandwidth is not available; and
outputting a positive acknowledgement message to the server when bandwidth is available.

4. The method of claim 3, further comprising reserving bandwidth for the uplink and downlink cards associated with the first message for a predetermined time.

5. The method of claim 4, wherein the predetermined time is equal to or greater than a running length time of a video.

6. The method of claim 4, wherein the predetermined time is equal to or greater than a time required to complete an authorization process.

7. The method of claim 2, further comprising:
when a second message has been received, outputting a second message acknowledgement; and
measuring a first time period.

8. The method of claim 7, further comprising:
determining if a third message has been received from the server;
determining if the first time period has expired;
releasing the reserved bandwidth when the first time period expires; and
outputting a positive acknowledgement to the server when the third message has been received.

9. The method of claim 7, further comprising determining if a third message has been received from the server when the second message has not been received, outputting a third message acknowledgement when the third message has been received, and determining if a second time period is being measured when the third message has not been received.

10. The method of claim 9, further comprising:
starting the second time period when the second time period is not being measured; and
determining if the second time period has expired when the second time period is being measured.

11. The method of claim 10, further comprising releasing reserved bandwidth when the second time period has expired.

12. A method of operating a server, comprising:
determining if a request has been received from an end user; and
outputting a first message to a controller when the request has been received, the first message having an associated uplink card and an associated downlink card.

13. The method of claim 12, wherein the first message requests to reserve bandwidth on the associated uplink card and the associated downlink card to support a unicast data stream.

14. The method of claim 13, further comprising:
determining if an acknowledgement message has been received from the controller; and
outputting a response to the end user after the acknowledgement message has been received.

15. The method of claim 14, wherein the response informs the end user that a selection is unavailable.

16. The method of claim 14, wherein the response indicates that a unicast data stream can begin.

17. A machine-readable medium having stored thereon sequences of instructions, the sequences of instructions including instructions which, when executed by a processor, causes the processor to perform:
determining if a first message has been received from a server, the first message having an associated uplink card and an associated downlink card; and
determining if a second message has been received from the server when the first message has not been received.

18. The machine-readable medium of claim 17, further comprising instructions which, when executed by the processor, causes the processor to perform determining if the uplink and downlink cards associated with the first message have bandwidth available to support a unicast data stream when a first message has been received.

19. A machine-readable medium having stored thereon sequences of instructions, the sequences of instructions including instructions which, when executed by a processor, causes the processor to perform:
determining if a request has been received from an end user; and
outputting a first message to a controller when the request has been received.

20. The machine-readable medium of claim 19, wherein the first message identifies an associated uplink card and an associated downlink card.
